(19) United States
(12) Patent Application Publication
(10) Pub. No.: US 2005/0194877 A1
(43) Pub. Date: Sep. 8, 2005

(54) Spark plug having multiple point firing points

(76) Inventors: Joseph B. Horn, Boulder, CO (US); Myron Muckerheide, Cedarburg, WI (US); Susan K. Schreiner, Cedarburg, WI (US)

Correspondence Address: HOLME ROBERTS & OWEN, LLP, 299 SOUTH MAIN, SUITE 1800, SALT LAKE CITY, UT, 84111, US

(21) Appl. No.: 10/793,156

(22) Filed: Mar. 4, 2004

(51) Int. Cl. H01T 13/02; F02M 57/06; H01T 13/20

(52) U.S. Cl. 313/141; 313/142; 313/143

(57) ABSTRACT

A spark plug is provided including a housing, a center electrode and an outer electrode. The center electrode has a firing tip extending out from the housing. The outer electrode has an annular surface surrounding the center electrode. The annular surface is formed with a toroid shape. The crest of the toroid shape is arranged to face towards the center electrode. The annular surface and the firing tip of the center electrode define a gap to convey a spark. The gap is defined at least in a plane substantially perpendicular to a center axis of the spark plug. In another embodiment of the invention, the outer electrode can include an end portion having a planar surface with a circular shape and an aperture defining an annular surface surrounding the center electrode.

### BACKGROUND OF THE INVENTION

1. The Field of the Invention

The present invention generally relates to a spark plug and more specifically, the invention relates to a spark plug having multiple firing points.

2. The Relevant Technology

A spark plug is used in internal combustion engines to generate a spark at sequential intervals. The sparks ignite an air-fuel mixture within a cylinder of an engine to create a contained explosion. A high voltage is applied to a center electrode of the spark plug. When the voltage jumps across a narrow gap between the center electrode and a ground electrode a spark is created.

Spark plugs are generally designed with a central electrode, an insulator and a ground electrode. Typically, the central electrode is a solid cylindrical pin that extends axially through the spark plug from one end to the other. The insulator surrounds the central electrode to insulate it from the ground electrode. One end of the spark plug includes an exposed portion of the central electrode to allow a wire carrying a current to be attached to the spark plug. The other end also includes an exposed portion of the central electrode and usually an L-shaped attachment attached to the ground electrode. The L-shaped attachment is positioned so that it is directed towards the central electrode. A gap exists between the L-shaped attachment and the central electrode so as to create a spark when current flows from the central electrode to the ground electrode. The gap must be adjusted accurately to provide the required spark to efficiently ignite the air-fuel mixture within the cylinder.

A portion of the spark plug is threaded for attaching it to an engine head directly above a cylinder. The treaded portion provides a tight fit between the engine head and the spark plug. When the spark plug is inserted into the engine head, a portion of the spark plug designed to created a spark is projected into the cylinder. The other end of the spark plug is electrically connected to a power source.

When in operation, an electrical charge is applied to the central electrode, which travels through the central electrode to the opposite end. The electrical charge must be sufficiently large to “jump” between the gap of the central and ground electrodes and create a spark at the precise moment. A piston moves in cycles within the cylinder. When the piston is in its latter portion of a compression cycle, the spark is created to ignite the pressurized air-fuel mixture, which in turn repels the piston to produce mechanical energy.

Many designs have been made to try to improve the efficiency of the spark plug by changing the structure, material composition and orientation of the gap. Some designs modified the L-shape attachment include an enlarged tip or cap on the central electrode. U.S. Pat. No. 5,731,655, for example, provided a spark plug with an outer annular electrode and an inner electrode having a disk-shaped element supported atop the inner electrode. This design, however, requires the tip to be properly aligned to provide a uniform gap. Otherwise, the disk-shaped element would be no more efficient than the standard L-shaped attachment.

Other devices modified the ground electrode to provide various gap sizes and geometries. U.S. Pat. No. 5,280,214, for example, provided a spark plug having a ring shaped ground electrode with a uniform annular hole to the outer diameter of the center electrode. This design also has its draw backs because the ring-shaped ground electrode can become offset or dislodged when a mounting post becomes bent or is not aligned properly.

U.S. Pat. No. 6,121,720 provided a spark plug including a large plurality of sharp edges on the center electrode, the ground electrode, or both to enhance spark propagation. Multiple variations of sizes and shapes included a number of cantilevered ground electrodes circumferentially and equidistantly spaced about the center electrode or an annular configuration. These configurations, however, provided sharp edges which periodically require regeneration by filing down the surface of the ground electrode.

In view of the above and other related drawbacks and limitations identified in the relevant spark plug designs, there is a need for a spark plug design that has a high efficiency with multiple firing points and provides proper gap spacing.

### BRIEF SUMMARY OF THE INVENTION

In various exemplary embodiments of the present invention, a spark plug is provided including a housing, a center electrode and an outer electrode. The center electrode has a firing tip extending out from the housing. The outer electrode has an annular surface surrounding the center electrode. The annular surface is formed with a toroid shape. The crest of the toroid shape is arranged to face towards the center electrode. The annular surface and the firing tip of the center electrode define a gap to convey a spark. The gap is defined at least in a plane substantially perpendicular to a center axis of the spark plug. In another embodiment of the invention, the outer electrode can include an end portion having a planar surface with a circular shape and an aperture defining an annular surface surrounding the center electrode.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an embodiment of a spark plug in accordance with the present invention;

FIG. 2 is an end view of an embodiment of a spark plug in accordance with the present invention;

FIG. 3 is a sectional side view of the spark plug of FIG. 2;

FIG. 4 is a detailed sectional view of the spark plug of FIG. 3; and

FIGS. 5 is a chart of data taken from test results of an embodiment of a spark plug in accordance with the present invention.

### DETAILED DESCRIPTION OF THE PREFERRED EMBODIMENTS

Reference will now be made in detail to the preferred embodiments of the present invention, examples of which are illustrated in the accompanying drawings. The various exemplary embodiments provide a spark plug including multiple firing points.

In the preferred embodiment of the invention, the gap between the center and ground electrode are preset, i.e., formed to have a particular gap width. In the typical spark plug, the ground electrode is L-shaped. This L-shaped ground electrode must be measured and adjusted to provide a proper gap width. This gap width is difficult to adjust within a tight tolerance. Also, if the L-shaped ground electrode is slightly bumped, such as when installing or setting the spark plug down, the gap can be compromised.

The present embodiment of the invention provides a gap that is not easily compromised. Also, the ring design provides a direct path for the flow of the fuel to reach the area where the spark occurs. In the L-shaped ground electrode, however, the structure shields a portion of the spark from the fuel. The direct path improves fuel usage and emissions because it allows the air-fuel mixture to have a more complete bum. The air-fuel mixture is not blocked from any structure in the electrode to initiate combustion.

In addition, the present embodiment of the invention provides a ground electrode with multiple firing points. The spark can fire from the central electrode to any point along the ground electrode or to multiple points along the ground electrode in 360 degrees. These multiple firing points reduce any potential of the spark not being fired.

In conventional L-shaped electrode designs, the spark is emitted from the center electrode to the bent portion of the L-shaped electrode, which is a small surface area. When the ground electrode becomes worn or fouled, for example, by oil deposits, carbon deposits, ash deposits, or glazing, the useable surface area for emitting a spark becomes drastically reduced. The surface area of the electrodes that are excessively worn or fouled can prevent or weaken a spark being emitted. In the present invention, the spark is emitted from the center electrode to any point along the ground electrode in 360 degrees, thereby providing more surface area for the spark to be emitted and resulting in a more reliable and longer lasting spark plug.

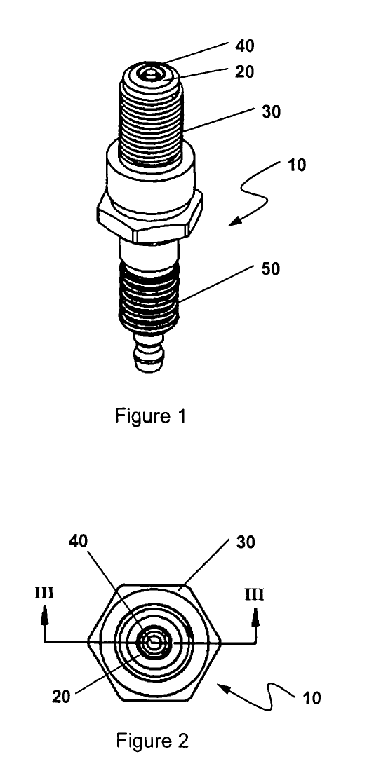

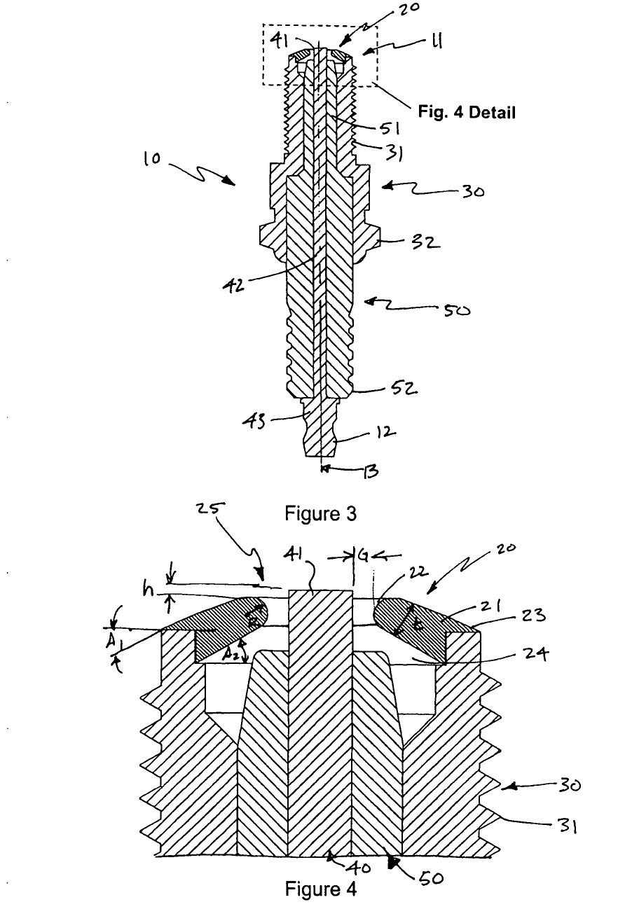

FIG. 1 illustrates one embodiment of a spark plug 10 in accordance with the present invention. The spark plug 10 includes an outer electrode 20 such as a ground electrode, a shell 30, a center electrode 40 and a housing 50. The spark plug 10 has a firing end 11 to emit a spark and a cable end 12 to be connected to spark plug cables (not shown). A center axis 13 generally runs through the center of the center electrode 40, as shown in FIG. 3. The spark plug cables intermittently provide a voltage to the center electrode when the spark plug is assembled in an engine. The spark occurs when the voltage jumps or arcs from the center electrode to the outer electrode when the outer electrode is provided as a ground electrode. If the voltage flow is reversed, the spark would occur when the voltage jumps or arcs from the outer electrode to the center electrode.

FIGS. 2-4 provide further detail of the spark plug 10 in accordance with the present embodiment of the invention. The center electrode 40 includes a firing tip 41, a center portion 42 and a connection tip 43. The center portion 42 is generally enclosed by the housing 50. At the firing end 11, the firing tip 41 of the center electrode 40 extends out from the proximal end 51 of the housing 50, which can be defined as the core nose 14. A space is provided around the core nose 14 and the outer electrode 20 and shell 30. The space may further include a void defining a volume between the outer electrode 20, the shell 30 and the housing 50 as shown in FIG. 4. When the spark plug 10 is in use, the air-fuel mixture can enter the void to cool the core nose components and provide better ignition within the cylinder. At the cable end 12, the connection tip 43 extends out the distal end 52 of the housing 50. A spark plug cable is attached to the connection tip 43 to apply a voltage through the center electrode 40.

The body or shell 30 includes a threaded cylindrical portion 31 and a hexagonal portion 32. The threaded cylindrical portion 31 allows engagement with internal threads of an engine cylinder port (not shown). The threads are used to attach or screw the spark plug into the engine so that the firing end 11 is inserted into the cylinder port. The hexagonal portion 32 is sized to allow a wrench to fit the shape of the hexagonal portion 32. In this manner, the spark plug 10 can be tightened when the threads are screwed into the engine.

The outer electrode 20 can be constructed in various shapes, such as a circular shape, a conical shape or a disk-like shape. The upper and lower surfaces 23, 24 can be planar or curved. When the upper and/or lower surface 23, 24 include a planar surface, it can extend toward the center electrode 40 at an angle A1, A2. The angle Al is defined by a planar surface of the upper surface 23 and a plane substantially perpendicular to the center electrode 40. The angle A2 is defined by a planar surface of the lower surface 24 and a plane substantially perpendicular to the center electrode 40. Angles Al and A2 are preferably between about 20 to about 35 degrees, and more preferably about 30 degrees, and need not be identical to one another. The thickness t between the upper and lower surfaces 23, 24 may vary in thickness or be constant depending on the angles of the upper and lower surfaces 23, 24. The thickness t is preferably between about 1.3 and about 1.7 mm.

In the preferred embodiment of the present invention, the shape of the upper and lower surfaces 23, 24 are angled and shaped to minimize sharp corners. By rounding the angling the upper and lower surfaces 23, 24, a more direct path is provided to the ground source. The elimination of sharp corners on all non-firing surfaces reduces the likelihood that the spark will arc to the wrong surface, thereby providing a controlled spark. A controlled spark is necessary to prevent misfiring a cylinder in the engine.

As shown in FIG. 4, the outer electrode 20 includes an end portion 21, an annular surface 22, an upper surface 23, a lower surface 24 and an aperture 25. The aperture 25 is formed in the outer electrode 20, which defines the annular surface 22 between the upper and lower surfaces 23, 24. The aperture 25 is preferably circular, but can also be arranged in a generally circular orientation having grooves, or sections cut into the end portion 21 in a finger-like manner. The annular surface 22 is arranged to surround the firing tip 41 of the center electrode 40 to provide a gap G.

The annular surface 22 can have a toroid shape. The term toroid is defined herein as a surface generated by a closed curve rotated about, but not intersecting or containing, an axis in its own plane. The American Heritage Dictionary, Second College Edition, Houghton Mifflin Co., 1982, 1985, page 1279. The curve used to create the toroid shape includes geometries such as elliptical, oval, arcuate, circular and other generally smooth, curved shaped geometries. The curve of the toroid shape faces toward the center electrode 40 and includes a portion having a radius R. The radius R of the toroid shape can be sized to provide a smooth transition from the upper surface 23 to the lower surface 24. The radius R is preferably sized between about 0.5 to about 0.7 mm, and more preferably about 0.6 mm.

The toroid shape includes a crest, meaning the outermost point of the curve in the toroid shape of the annular surface 22. The crest provides the smallest gap G distance between the center electrode 40 and the outer electrode 20 if the firing tip 41 and the crest are arranged inline with each other.

As shown in FIG. 4, the outer electrode 20, or more specifically, the end portion 21 of the outer electrode 20 is arranged on the firing end 11 of the spark plug 10 so that the aperture 25 is assembled over the center electrode 40. The upper surface 23 may be positioned even with, above or below the outer end of the firing tip 41 of the center electrode 40. As illustrated in FIG. 4, the outer end of the firing tip 41 is positioned above the upper surface 23 of the outer electrode 20 defining a height h.

The gap G can be defined as being at least in a plane substantially perpendicular to a center axis 13 of the spark plug 10. The gap G has a predetermined dimension that is measured as shortest distance between the outer electrode 20 and the center electrode 40. In most cases, this dimension will be the distance between the outer most edge or crest of the toroid shape of the annular surface 22 and the closest surface of the center electrode 40. The dimension of the gap G can range between about 0.5 mm to about 5 mm, preferably about 0.5 mm to about 1.0 mm, and more preferably about 0.6 mm to about 0.8 mm.

The specific dimension of the gap G depends on the application in which the spark plug 10 is used. The dimension of the gap G affects the electrical energy potential that exists across the gap G. A lower electrical energy potential across the gap G results in a less powerful spark. If the gap G is not sized properly, optimum combustion can not be achieved and localized build-up of heat may occur that accelerates erosion of the firing tip 41 and/or the annular surface 22. When the gap G is too large for a given engine requirement, the voltage required to cause the spark to arc across the gap G becomes impractical.

The outer electrode 20, such as a ground electrode can be made of a conductive material, for example, platinum, a platinum alloy, aluminum, boron, titanium, molybdenum, manganese, silicon, carbon, nickel, vanadium and iron. The annular surface 22 or the end portion 21 of the outer electrode 20 can be made of a material that is different than the remainder of the outer electrode 20. Generally, the surface that receives the spark is apt to receive most of the wear or damage. As such, this surface can be reinforced by making the surface from wear and damage resistant material. In addition, the toroid shape can be applied to the annular surface 22 by a process such as by welding, pressing, or forging in the material. Additionally, the electrodes may include other materials, such as tungsten, vanadium, depleted uranium, rhodium, iridium, and palladium, chromium, copper, barium aluminate, iron, thoria and nickel.

The center electrode 40 can be a cylinder or rod-like structure, which passes through the housing 50. The firing tip 41 and the center electrode 40 can have different configurations. For example, the firing tip may be configured to have a cone shape or a spherical end. In the preferred embodiment of the invention, the cross-section of the center electrode 40 and the firing tip 41 are same. The cross-section can measure between about 1.0 and about 3.0 mm in diameter. The center electrode 40 can be made of an electrically conductive material, such as a metal like a Ni-based alloy having an embedded heat-conductor core, such as Inconel 600. If the firing tip 41 is made of a different material from that of the center electrode 40, another type of conductive material, such as a noble metal, can be used that is selected to provide longer durability. For example, the firing tip can be made of an alloy such as Pt₂₀Ir.

An example discussed below illustrates an embodiment of the invention and should not be construed to limit the invention.

### EXAMPLE

In the example, a spark plug is provided for a 125 cc motorcycle engine in accordance with the present invention. The spark plug includes an end portion of an ground electrode having a circular shape with a diameter of about 12.14 mm. The end portion has a thickness of about 1.65 mm at an end assembled to the shell of the spark plug. The end portion thickness tapers to a thickness of about 1.33 mm at another end closest to a center electrode measured just prior to a toroid shaped surface. An aperture is formed in the center of the end portion having a diameter of about 3.8 to about 4.0 mm. The toroid shaped surface is formed in the wall defining the aperture. The toroid shaped surface has a diameter of about 0.61 mm.

The end portion extends from the shell at an angle. The angle is defined by one of an upper surface and a lower surface of the end portion and a plane substantially perpendicular to the center electrode. The upper surface extends toward the center electrode at an angle of about 25 degrees at the end assembled to the shell and an angle of about 20 degrees at the end closest to the center electrode. The lower surface extends to toward the center electrode at an angle of about 30 degrees. The angle in the lower surface provides a void or space around the core nose of the spark plug. The angles also provide a transition from the vertical shell to the horizontal gap between the center electrode and the ground electrode.

The center electrode has a cylindrical shape with a cross-section having a diameter of about 2.44 mm. The end portion is arranged to place the aperture equally spaced from the center electrode. This spaced distance provides a gap of about 0.68 to about 0.78 mm between the center and ground electrodes. The center electrode extends above the upper surface of the ground electrode by about 0.3 mm.

### Test Results

Various spark plugs designed for a 250 cc motor cycle engine were tested in a dyno machine to evaluate the performance results. Spark plugs 1 and 2 had annular surfaces with a toroid shape as generally described above. Spark plug 3 did not have a toroid shape, which was used to compare its design to spark plugs 1 and 2. Spark plug 3 included an annular surface surrounding the center electrode that was planar instead of being curved.

Spark plug 1 had a gap that measured between about 0.8 and 0.9 mm and an inner diameter of about 3.9 mm. The inner diameter being measured on the annular surface at the crest of the curved surface. Spark plug 2, having a similar arrangement as spark plug 1, had a gap measuring between about 0.7 and 0.9 mm and an inner diameter of about 3.9 mm. Spark plug 3 had a gap measuring about 0.9 mm and an inner diameter of between about 4.1 and 4.2 mm.

Each spark plug was tested on the dyno machine. The results were surprising and showed that the toroid shape design had the best performance. Spark plug 1 measured a maximum power of about 53.3 hp and a maximum torque of about 32.8 ft-lbs. Spark plug 2 measured a maximum power of about 53.2 hp and a maximum torque of about 32.3 ft-lbs. Spark plug 3 measured a maximum power of about 52.6 hp and a maximum torque of about 32.8 ft-lbs. The difference between the maximum power of Spark plug 1 and spark plug 3 is 0.7 hp, which is a great benefit in the motorcycle industry. The present invention provides a spark plug that bums the air fuel mixture more efficiently to provide a cleaner burn and more powerful stroke.

While the invention has been described with reference to the specific embodiment described, the descriptions are only illustrative and are not to be construed as limiting the invention. As such, the optimal dimensional relationships for the parts of the preferred embodiment of the invention can be varied in size, materials, shape, configurations, form, function and manner of operation. The optimal dimensional relationships, use and assembly that are readily apparent to those skilled in the art and all equivalent relationships to the embodiments illustrated in the drawings and described in the specification are intended to be encompassed by the present invention. The various embodiments of the spark plug can be used in conventional internal combustion engines for motorcycles, automobiles, boats, airplanes, lawn mowers and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A spark plug comprising:
a housing;
a center electrode having a firing tip extending out from the housing; and
an outer electrode having an annular surface surrounding the center electrode, the annular surface having a toroid shape with the crest of the toroid shape facing towards the center electrode, the annular surface and the firing tip of the center electrode defining a gap to convey a spark, the gap being defined at least in a plane substantially perpendicular to a center axis of the spark plug.

2. The spark plug of claim 1, wherein the outer electrode includes a planar surface being shaped to extend towards the center electrode.

3. The spark plug of claim 2, wherein the planar surface extends toward the center electrode at an angle, the angle being defined by the planar surface and a plane substantially perpendicular to the center electrode.

4. The spark plug of claim 3, wherein the angle is between about 20 to about 35 degrees.

5. The spark plug of claim 3, wherein the angle is about 30 degrees.

6. The spark plug of claim 2, wherein the planar surface is a lower surface of the outer electrode.

7. The spark plug of claim 1, wherein the center electrode is positioned below the crest of the toroid shape.

8. The spark plug of claim 1, wherein the outer electrode is shaped in a disk-like shape.

9. The spark plug of claim 1, wherein the outer electrode is shaped in a conical shape.

10. The spark plug of claim 1, wherein the outer electrode has a thickness between about 1.3 and about 1.7 mm.

11. The spark plug of claim 1, wherein the toroid shape of the annular surface has a radius between about 0.5 to about 0.7 mm.

12. A spark plug, comprising:
a housing;
a center electrode having at least a portion extending out from the housing at a firing end of the spark plug; and
an outer electrode including an end portion adapted to receive a spark, the end portion having a planar surface with a circular shape and an aperture defining an annular surface surrounding the center electrode, the center electrode and the annular surface defining a gap to convey a spark, and the annular surface having a toroid shape with the crest of the toroid shape facing towards the center electrode.

13. The spark plug of claim 12, wherein the planar surface extends toward the center electrode at an angle, the angle being defined by the planar surface and a plane substantially perpendicular to the center electrode.

14. The spark plug of claim 13, wherein the planar surface is a lower surface of the outer electrode.

15. The spark plug of claim 13, wherein the angle is between about 20 to about 35 degrees.

16. The spark plug of claim 15, wherein the angle is about 30 degrees.

17. The spark plug of claim 12, wherein the circular shape of the outer electrode is a disk-like shape.

18. The spark plug of claim 12, wherein the circular shape of the outer electrode is a conical shape.

19. The spark plug of claim 12, wherein the outer electrode has a thickness between about 1.3 and about 1.7 mm.

20. The spark plug of claim 12, wherein the toroid shape of the annular surface has a radius between about 0.5 to about 0.7 mm.
